(19) United States
(12) Patent Application Publication
(10) Pub. No.: US 2017/0133766 A1
(43) Pub. Date: May 11, 2017

(54) DISH BILLBOARD SYSTEM

(71) Applicant: Simeon BROWN, Mooresville, NC (US)

(72) Inventor: Simeon BROWN, Mooresville, NC (US)

(21) Appl. No.: 15/346,727

(22) Filed: Nov. 8, 2016

Related U.S. Application Data
(60) Provisional application No. 62/253,724, filed on Nov. 11, 2015.

(51) Int. Cl. H01Q 15/16; G06Q 30/02

(52) U.S. Cl. CPC H01Q 15/16; G06Q 30/0241

(57) ABSTRACT

A dish billboard system comprising a dish wrap and methods for personalized or customized outdoor advertising and display on a telecommunications satellite dish. The dish wrap provides a thin, smooth, seamless and uninterrupted surface on which one or more indicia laminated on the wrap are displayed.

### TECHNICAL FIELD OF THE INVENTION

This application claims the benefit of priority from U.S. Provisional Patent Application 62/253,724, filed Nov. 11, 2015.

The invention relates to the field of advertising, promotion and marketing using three-dimensional outdoor display devices. In particular the invention relates to a method of advertising or displaying information using a customized open-air mounted satellite dish as a small scale billboard or personalized signage.

### BACKGROUND

There are many effective ways in which businesses or others may deliver a message to the public. For decades, outdoor displays or billboards have been used as one way of displaying advertising and promotional messages to a passing audience. In this way, billboards have traditionally been effective for establishing a brand name in the minds of viewers. According to a study of the impact of billboard advertising that was conducted in 2009, 71% of Americans often look at the messages on roadside billboards (traditional and digital combined), and more than one-third (37%) report looking at an outdoor billboard ad each or most of the time they pass one. The study further indicates that more than half of billboard viewers over the age of 18 or older have talked about something funny observed on a roadside billboard or learned about an upcoming event in which they became interested. Outdoor display ads also influence consumer shopping decisions. Most outdoor billboards are restricted to commercial areas because of local zoning ordinances, or because the size of the billboards makes their placement in areas that are not exposed to high traffic impracticable. The cost is also relatively high, and there is often an accompanying contract commitment to use the billboard for a specific length of time that makes the advertising quite expensive. Another drawback is that because billboards are generally intended to be viewed by people driving by them in vehicles, they may not be easily read due to the speed of traffic. Additionally, the messaging may be more impersonal and less likely to be one with which a fan consumer would readily associate. As a result, innovative opportunities are needed which offer outdoor advertising that overcome the aforementioned disadvantages of lack of personal association or connection and the limited time to communicate information with lasting impact, which are typical of traditional billboards. Further, outdoor displays are needed which can be preferentially adapted by individual consumers to display their fan loyalties or other personal preferences or other targeted and narrowly customized information, as these are not readily provided by traditional outdoor signage.

The present invention builds upon the history of effective outdoor display advertising and the strong associations consumers maintain with favorite brands such as sports teams or other social and cultural affiliations to provide a personalized means of advertising that can be customized, either by consumers who use residential satellite dishes or by other parties, with information that is appealing to those consumers or to groups of other consumers or people who have common interests in a geographic location. Fan affiliation and loyalty, for example for sports teams, colleges, games and the like, is more intense than consumers may experience in relation to other consumer brands. The reasons that have been theorized for the extreme nature of fan loyalty include the high entertainment value of the preferred brand; appreciation of team (or other fan brand) history and tradition; group affiliation; and bonding between likeminded fans. It is known in the advertising industry that sports fans are extremely dedicated to their preferred brands, and that they have a high awareness and understanding of those brands. Fan consumers also display a high level of enthusiasm for brand memorabilia, such as clothing, posters and other merchandise, and fan loyalty provides significant motivation for discretionary spending for such items. In addition, this spending is for very personal yet conspicuous consumption. For example, an Arbitron (The Nielsen Company) report of a 2009 survey reported in 2015 states that two out of three sports team fans show their team loyalty by displaying team memorabilia in their homes. The Arbitron National In-Car Study, 2009 Edition, Arbitron, Inc. There however has not until now been a means of personally displaying fan loyalty or other affiliations, hobbies or preference in a manner that could be readily ascertained by passersby in a residential setting. Such a method is provided by this invention.

### SUMMARY OF THE INVENTION

The invention comprises a system for displaying information on the dish surface of a satellite dish receiver comprising a receiver dish of a satellite dish system; a detachable information layer laminated onto the dish surface, wherein the detachable information layer comprises selected customized information forming a display, and further wherein the customized information used in the display is selected according to the preference of the user of the dish satellite system.

One aspect of the present invention relates to a method of advertising personalized display materials on a surface of a telecommunication satellite dish.

In another aspect, the invention provides a method of sports fan or hobbyist participation in celebrating or cheering for a preferred activity by selecting and displaying indicia identifiable with that activity in a personalized outdoor display.

The invention further provides multifunctional laminating indicia comprised of promotional or other written or graphic communications, which are applied to one or more surfaces of a telecommunications satellite dish.

In yet another aspect, the invention provides telecommunications satellite dishes modified by the application of personalized advertising indicia that have been selected by the consumer owner or lessee of the dish.

### BRIEF DESCRIPTION OF DRAWINGS

FIG. 1 is an isometric drawing of a residential telecommunications satellite dish having advertising indicia according to the invention appliquéd to a parabolic receptor surface.

FIG. 2 is an isometric drawing of a conventional telecommunications satellite dish mounted on a building roof.

FIG. 3 is a segmented appliqué of one possible laminating indicia that can be chosen by a satellite dish customer for personalization of a dish surface.

FIG. 4 is a transverse sectional view along the line 4-4 of FIG. 3.

FIGS. 5A, 5B, 5C, 5D and 5E are two-dimensional views of representative dish wraps with selected promotional laminating indicia that may be displayed according to the invention.

FIG. 6 is a perspective view of a dish configuration including a laminated dish wrap with advertising indicia affixed to the receptor surface of the dish.

FIG. 7 is a perspective view of a dish billboard system according to the invention comprising an electronic display.

FIG. 8 is a transverse sectional view of an electronic display system according to the invention.

FIG. 9 is a transverse sectional view of a dish billboard system according to the invention comprising a heating element layer.

### DESCRIPTION OF EMBODIMENTS

The methods and devices of the invention define a new category of advertising that could colloquially be termed “dishboard” or “dish billboard” advertising because it implements devices and techniques for converting small sized satellite dishes such as are used by residential and small business customers into means for transmitting, by published or broadcast information, personalized messages or targeted advertising or promotional information. The devices of the invention comprise appliqués of laminating indicia that are detachable and adhesively fastened to one or more surfaces of a satellite dish. The term “laminating indicia,” as used herein means a single layered or multilayered sheet that is imprinted by any means with readable textual or graphic information, and which is incorporated into an appliqué. The appliqué is then laid over or otherwise affixed to a dish receptor surface. Laminating indicia useful in this invention include materials illustrated or otherwise labeled with a name, mascot, logo, trademark, team name, public message or other printed information. The laminating indicia are chosen according to the personal selection of the dish customer or user. The appliqués are permanently applied, meaning they are not removed when the satellite dish receiver is in use, and they can be readily removed, discarded and replaced with different appliqués. The term “user,” as used herein, is not limited to customers who purchase or lease or otherwise control the satellite dish but may also include the operators of the dish satellite transmission system, such as communications companies, as well as third party advertisers who may contract with the communications companies or the users of the satellite dish system to display promotional information on their behalf.

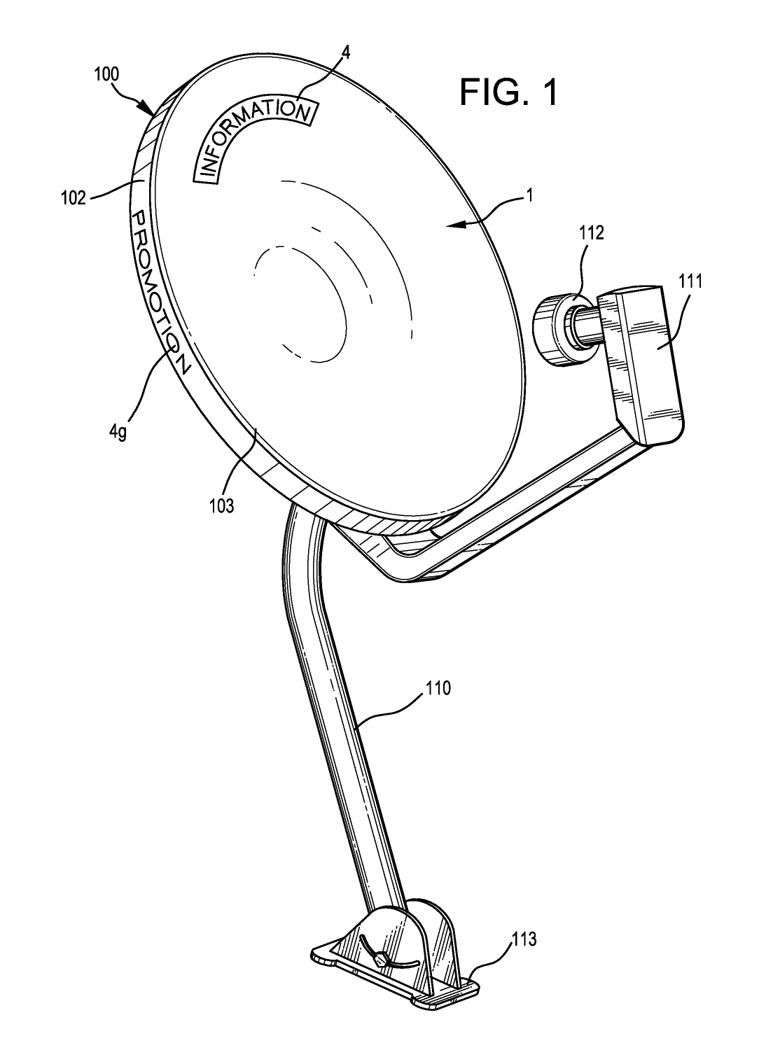

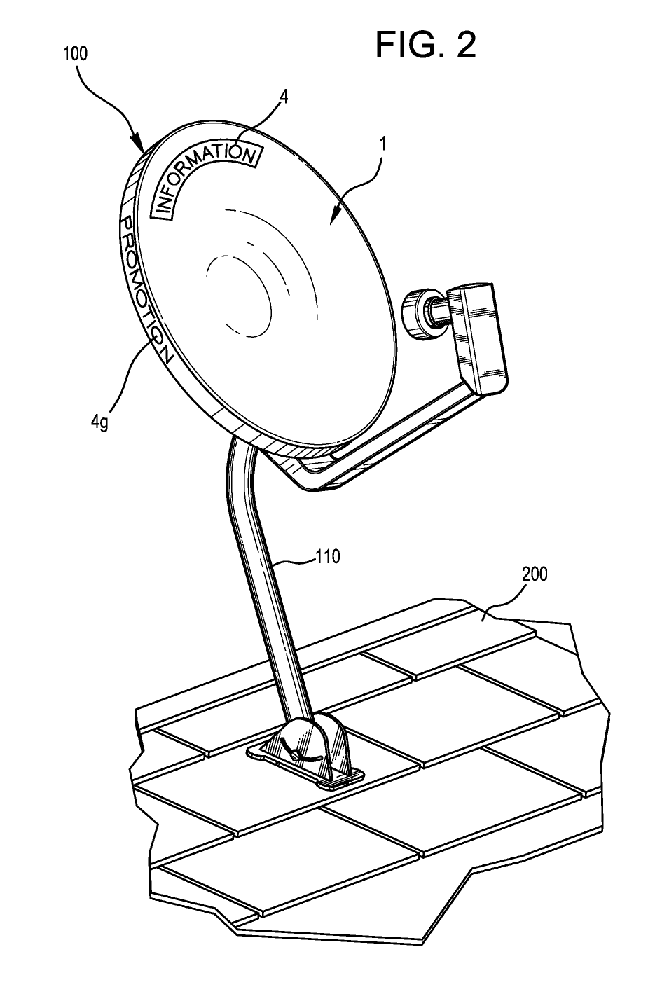

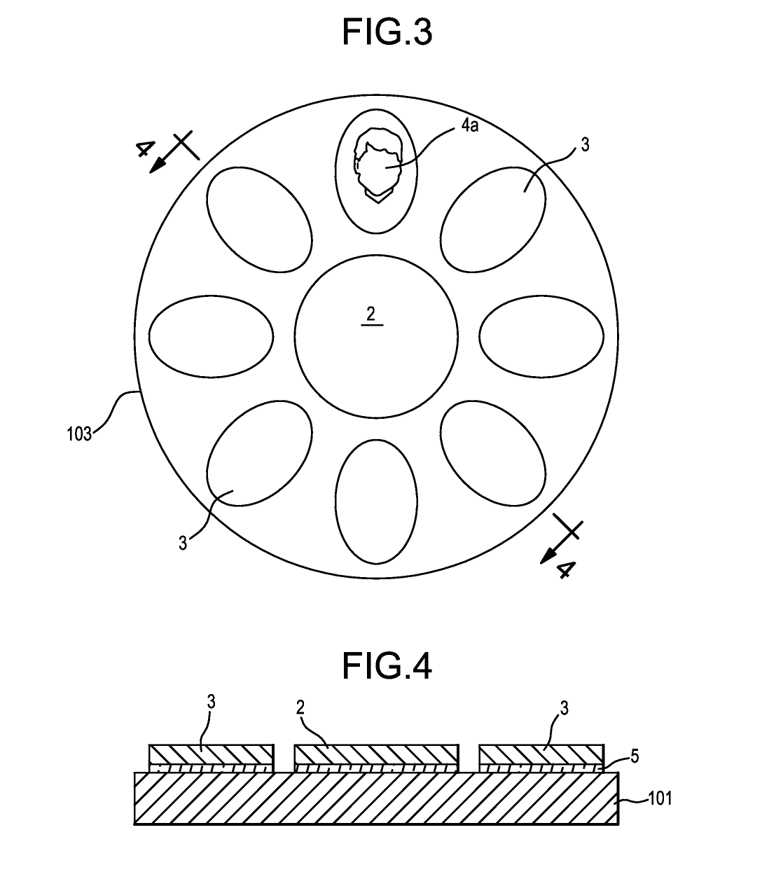

According to FIGS. 1 and 2, dish wrap 1 may be applied to substantially the entire dish receptor surface 101 of a satellite receiver dish 100. Alternatively, the dish wrap may take the form of one or more appliqués that cover only a portion or portions of the dish surface 2, 3, as shown in FIG. 3. A preferred surface for application is the dish receptor surface 101, which is an interior, typically parabolic surface of the dish. In this regard the dish wrap, which resembles a film, may be spread over the surface 101 to the edges thereof at the perimeter 103. Because of the spherical nature of the surface of some dishes, the laminating indicia 1 can be affixed with and display the indicia while shielding its visibility at certain angles. It is also within the scope of the invention that the exterior surfaces of the dish 100 could also be treated with appliqués that include laminating indicia. FIG. 1 further exemplifies application of laminating indicia 4g along the dish receptor side edge 102. The dish wrap could similarly cover the entire satellite dish, for example if the user wanted to cover the dish with specific colors, an image or pattern,

FIG. 3 provide a layout of partial appliqués of laminating indicia that cover a large portion of the surface area of the dish receptor surface but do not entirely occlude the surface. It should be appreciated that such use of multiple appliqués may take any configuration or arrangement and any conceivable combination of laminating indicia or other information desired to be transmitted.

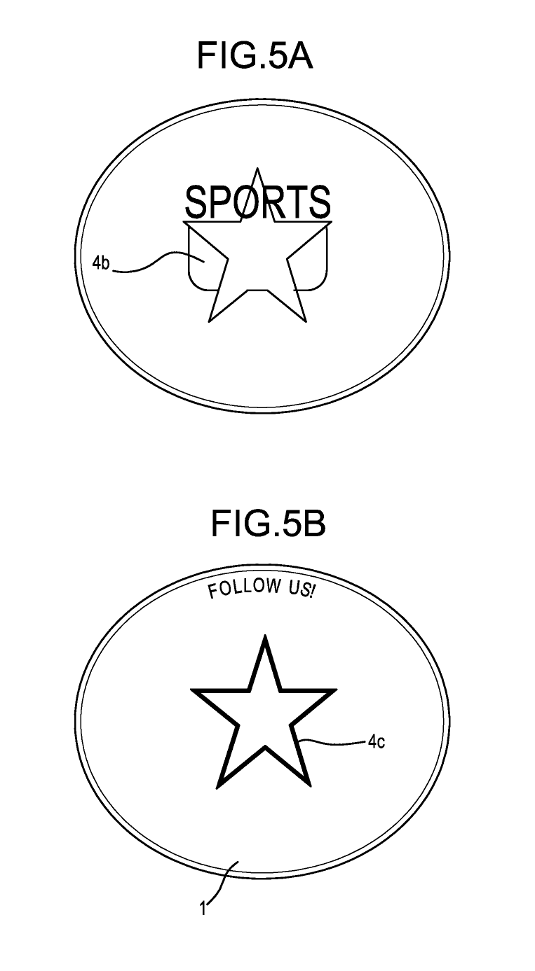

An exemplary application according to an embodiment of the invention, shown in FIG. 4, comprises appliqués 2, 3 which are attached to the dish receptor surface 101 by means of an adhesive layer 5. In this regard the adhesive layer 5 is positioned directly over and in contact with the portion of the dish receptor surface where the appliqué(s) is to be displayed, and the under surface of the appliqué is affixed to the adhesive. As adhesive means are contemplated glue, static adhesion means, tape, heat shrinking layers or other known means of affixing flexible films to a solid surface. In this respect the appliqués are also preferably stretchable so they can be pulled at the edges to be spread tautly and smoothly over the dish receptor surface area. The appliqué further includes laminating indicia incorporated on the surface thereof, or the entire appliqué itself may be a single layer that serves as the laminating indicia.

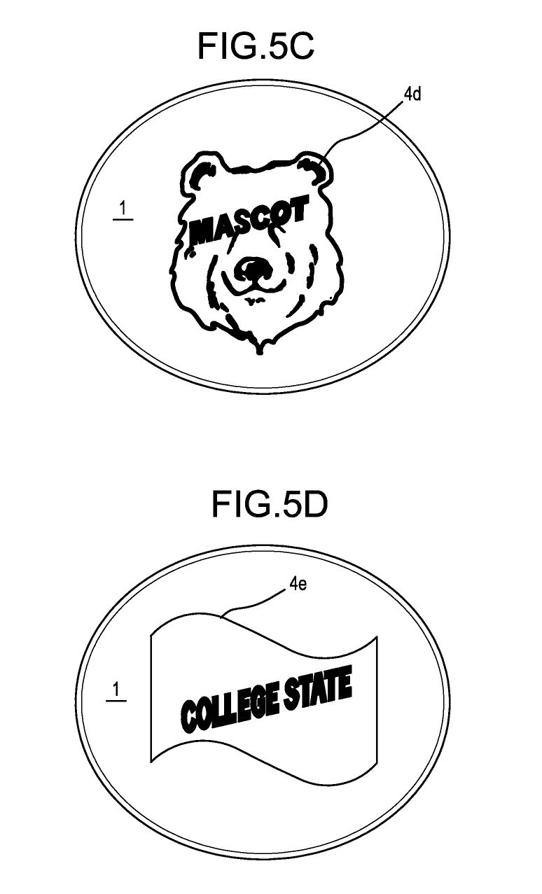

Suitable laminating indicia, as exemplified in FIG. 5 may include images of team mascots or logos, college pennants, flags, colors or names, team names or slogans, business trademarks or brand names, well known symbols which may or may not be in the public domain (e.g. a religious emblem), or images of individuals such as the dish user or groups of persons at the user's choice. It must be emphasized that any information a user might want to convey to others could be converted to laminating indicia incorporated into the dish appliqués. Appliqués with laminating indicia 4g may optionally be including along all or some portion of dish side edge 102 (see FIG. 1); however an advantage of placing the information on only the receptor surface is that the exterior appearance of the dish, which generally includes the side edges, can be kept neutral in relation to the surrounding environment. This may be particularly desirable in a residential setting. Three dimensional laminating indicia, e.g. raised mascot or cartoon characters, puffed printing or angular, three dimensional structures are also within the scope of the invention.

The dish billboard system comprising the new advertising means of the invention may be mounted on its own ground support, such as a pole 110, which is connected to a mount 113, as shown in FIGS. 1-3. The pole may be located adjacent to the building being served by the satellite communications, or it may for example be mounted on a side wall, or on the roof structure 2 as shown in FIG. 2. In any of these mounting configurations, the dish will be oriented to receive the signal from satellite transmissions and will therefore also orient its display in that direction to be perceived by viewers. Mounting means for the dish itself are not features of the claimed invention, and it is noted that the pole 110 and mount 113 can be according to any conventional selection or configuration known to those having ordinary skill in the art. The signals received by the satellite dish receiver are usually transmitted from the dish receptor surface to a feed horn 112 that is connected to a conduit element 111. The feed horn 112 receives and amplifies the signals and removes background noise and relays them via the element 111 to a receiver within the residence or building for conversion to broadcast images, internet communications or sound.

According to the embodiment of FIG. 3, the dish appliqué may be comprised of one or more separate appliqués that only partially cover the dish surface. In the example of FIG. 3, a central appliqué 2 may be incorporated along with other peripherally positioned appliqués 3 to form a pattern or organized so as to convey the information being presented on the laminating indicia. FIGS. 5A, 5B, 50, 5D and 5E represent non-limiting examples of laminating indicia that may be included on the appliqué.

The following non-limiting examples describe some possible applications of the personalized advertising method of the invention. The laminating indicia may reflect a particular sports season, and the dish wrap can be changed at the end of one season and the start of another. The information may reflect a public awareness month or display other useful information to the community. For example, the dish wrap may, according to the method of the present invention, include a pink ribbon symbol for breast cancer awareness or with the red ribbon symbol typically used as reminders against drunk driving. National or local flags or event notifications may also form appliqués. Alternatively a printed slogan may be used. Political campaign advertising may also be imprinted to show personal political affiliations or as a contemporary and innovative yard sign to build campaign momentum and increase candidate name recognition. Various social and cultural affiliations can also be displayed.

The foregoing examples are not intended to be limiting in any way, as any conceivable information that serves an advertising or notification purpose, and which can be printed on physical media or otherwise presented by digital means is within the scope of this disclosure.

As previously mentioned, the laminating indicia may cover the entire surface of the dish, or it may be segmented as part of a design or pattern, or it may cover one selected area. For example, FIG. 4 provides a cross-sectional view of a dish surface 1 on which is mounted a segmented design (FIG. 3). The appliqué is comprised of a printed display layer 2 and an adhesive layer 3. The placement of the appliqués (or cutouts from a whole dish appliqué) may be selected to enhance the signal strength of the dish. In a further embodiment, the appliqué can be similar to that used for vehicle advertising wraps, in which the entire exterior surface of the vehicle becomes signage. As also previously noted, FIGS. 1-2 show an appliqué that covers the entire receptor surface of the dish without signal impairment.

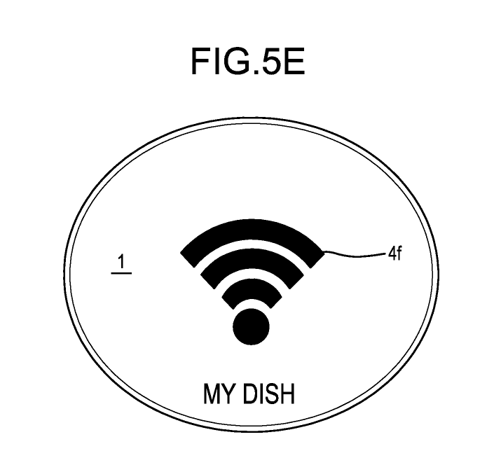

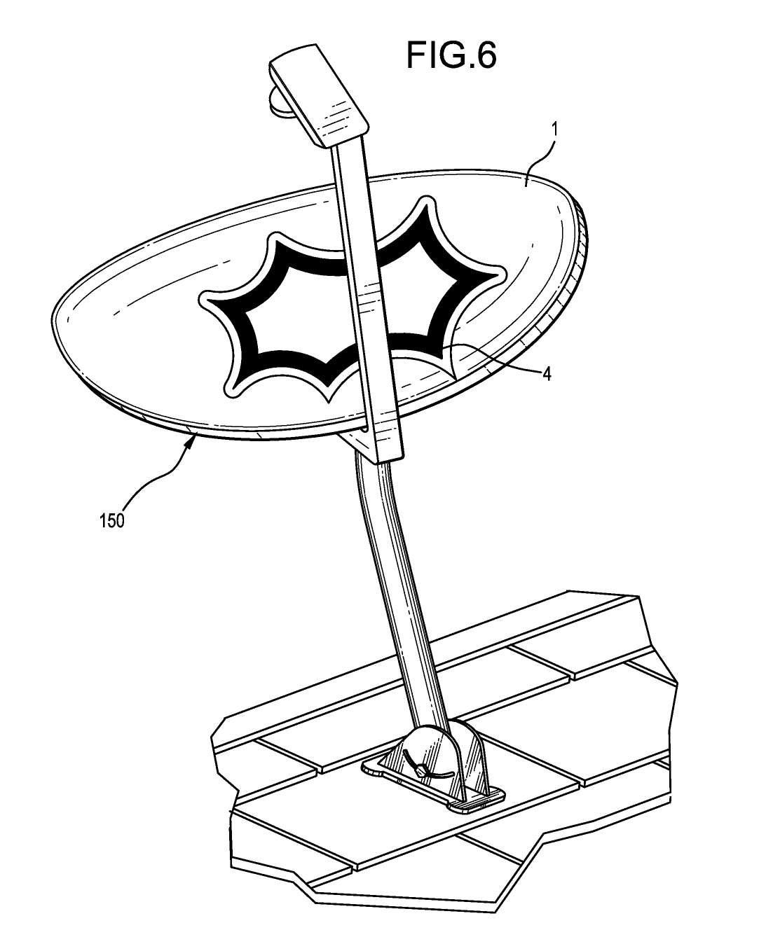

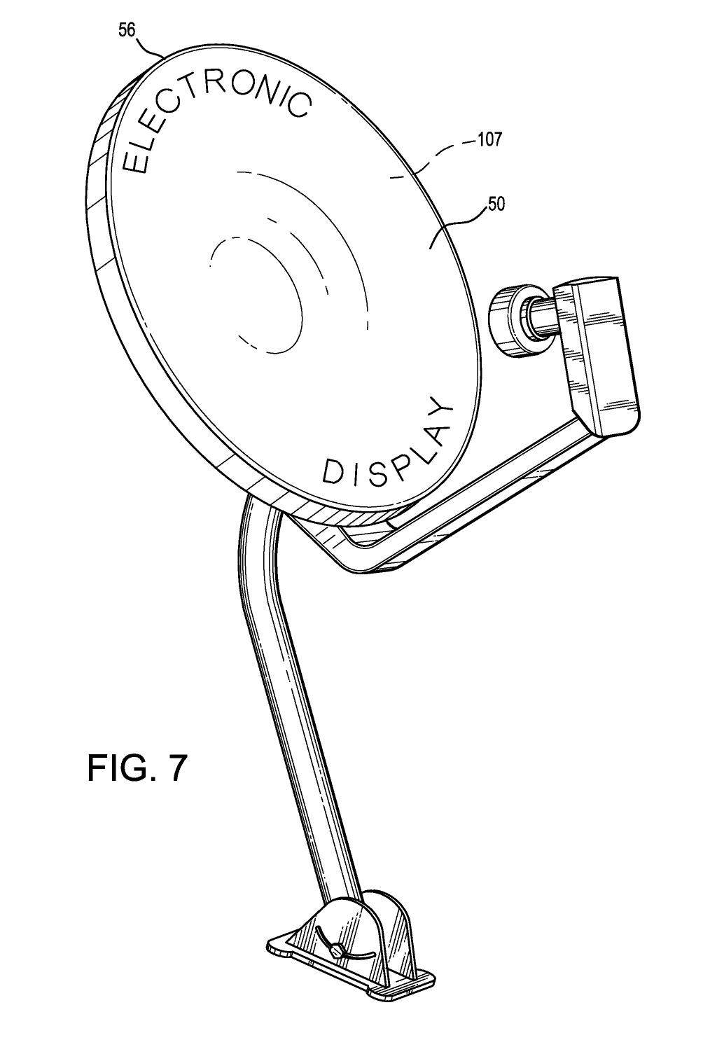

Newer developments in satellite dish design, especially for the small user market, have led to dishes that are not completely circular or not at all spherical in shape, as well as designs of varying size. The dish wraps of the invention may be designed and sized to place the display information at optimal locations on the receptor surfaces of such dishes. FIG. 6 is a representation of a spherical dish 150 of unequal radius bearing a dish wrap of a team logo. In the embodiment of FIG. 7, the dish wrap provides an electronic dish wrap 50, which may for example incorporate light emitting diode (LED) or liquid crystal display (LCD) technology that enables transmission of electronically generated images across the surface of the receptor dish surface 101. The electronic dish wrap 50 may be powered by a power source 56, which may further be selected from batteries, solar cells, wiring to direct current or other power supply means. The location of the power source may be any position that allows communication of electricity from the power source to the LED microstructures in the display. An example of such an electronic dish wrap 50 according to FIG. 8 may include a conductive transmitting layer 51 embedded with LED microstructures 52, this layer forming the display. When current is passed through the conductive layer the LED microstructures are illuminated according to the design and patterns formed by their arrangement. Without limitation, other light-emitting microstructures, for example liquid crystal displays (LCD) may be incorporated into the conductive transmitting layer. The embodiment of FIG. 8 may further include a surface protective layer 53. This layer may also be refractory. Alternatively, the LED microstructures can be surface-mounted on the conductive layer. It should be noted that multiple conductive transmitting layers may be included. If adhesive layers are included, as may be the option, such materials are selected so as not to interfere with the function of the electronic transmission layers. A suitable film for use in an electronic dish wrap system may be selected from those conventionally supplied for the purpose of receiving and broadcasting electronic images.

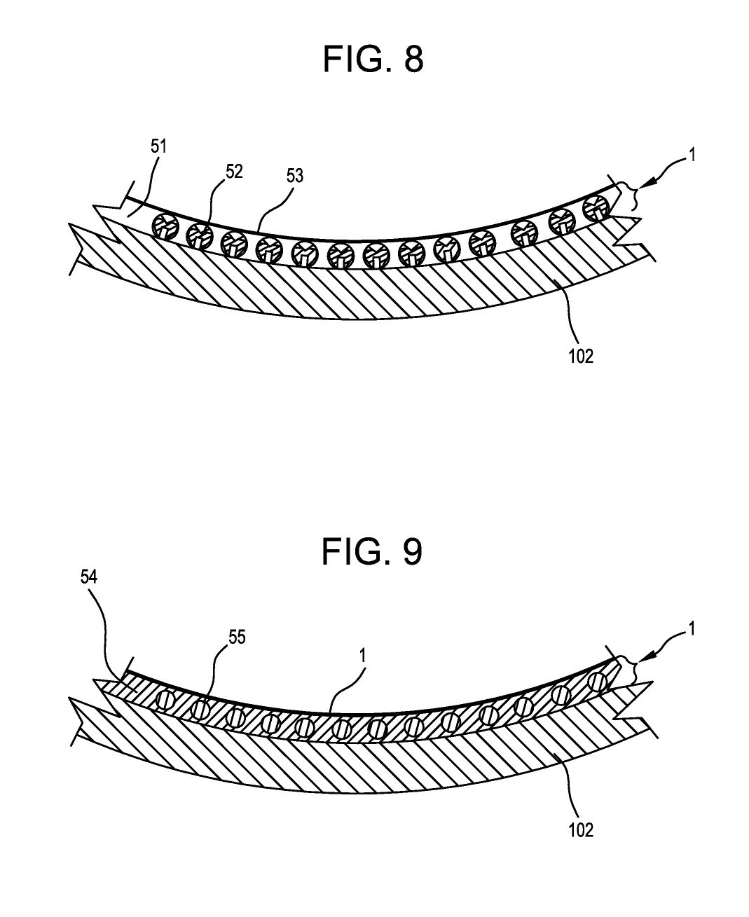

FIG. 9 represents a further embodiment of the invention in which heating wires 55 are integrally incorporated into the appliqué in an electrically conductive layer 54 beneath the laminating indicia 1. By this means the heating wires can be powered to warm the dish receptor surface in cold weather to melt ice or frost. This defrosting element clears the dish surface to maintain good signal transmission, and further enables uninterrupted display of the dish signage by preventing occlusion by snow and ice. When heating wires or other heating or even electrical means are used, the materials of the appliqué should necessarily be chosen to be compatible and resist degradation from heat or fire. Flame retardant materials are in this regard preferred. Magnetically conductive layers may also be included in the appliqué.

The laminating indicia and the appliqués of the invention may be fabricated from any material that can suitably adhere to the metallic or composite surface of a telecommunications satellite dish. For example, the material in its most elementary form can be a printed vinyl or other polymeric layer adhered to the dish surface by an adhesive. The material is preferably weather resistant and also resistant to UV light or other light sources that cause ink fading. It should not have properties that would interfere with the operation of the dish receptors. This is particularly desirable if the entire surface of the dish is to be covered. One example of a suitable polymeric layer material is a 2.0 mm adhesive-backed polyvinyl chloride (PVC). Other examples of suitable materials include polyethylenes, vinyls, acetates and magnetized layers. In certain embodiments, the appliqué material can be modified to provide certain useful properties. For example, it can provide a masking function over the dish surface. It can be modified to include solar receptors that receive and passively store solar energy or provide a conduit for collection of such energy. The film itself may be charged or otherwise modified to improve dish reception. It can provide electrical conductivity to fine defroster wires (as are used in car windshields) that can be powered by very low voltage current to prevent freezing accumulation on the dish surfaces. In this regard the appliqués of the invention can help to eliminate disruption of satellite service by aiding in maintaining reception of the service signal by blocking the accumulation of snow or ice. In a preferred embodiment, as a protective function the appliqué substantially seals the receptor surface of the dish, thereby shielding the structure from the snow effect and facilitating continued reception and good signal strength performance. In this regard any need that might exist for a separate dish cover that must be removed before the dish receiver can be used is obviated. The laminating indicia can also be imprinted in more than one dimension so that different images are displayed depending on orientation and the direction from which the dish wrap is viewed, or depending on the level of light exposure. Three-dimensional appliqués and digital displays are also contemplated by this invention.

The dish wrap systems of the invention do not affect the surface profile of the satellite dish as the appliqués are laminated directly onto its surfaces, and they are constructed of materials which do not interfere with signal reception or even transmission. Accordingly, full and uninhibited use of the dish is possible while the wrap remains installed. The layers are stretchable, so that they can be permanently stretched, tautly and smoothly, over the dish surface without air gaps. The film is also thin so that no thickness is provided which would impede the satellite signals. While permanently applied, the films are detachable and therefore removable, but they are typically not designed or intended for reinstallation or re-application to the dish surfaces. The dish wrap remains in place at all times, even when the dish is in use, and can be replaced at the user's option if it is desired that the laminating indicia or information published thereon be changed. Because the wraps can remain in place during dish use, they are ideal vehicles for advertisements and as channel of communication in the surroundings where the dish is located.

The present invention is not limited to these particular foregoing embodiments. The dish wrap embodies any form or configuration of appliqués to be laminated or otherwise printed or deposited indicia and should not be construed as limited to the embodiments set forth herein. Thus, the invention contemplates the use of any indicia for an outdoor advertisement-display as would be apparent to one having ordinary skill in the art.

The patterns of the various logos or graphic images or text that can be used as non-electronic laminating indicia may be printed as a whole sheet or cut, for example by die cutting. When the materials are die cut, they may be supplied for installation in perforated sheets, from which the appliqué itself may be punched out or easily detached. Alternatively, they may be fully precut and ready for installation as-is. Preparation of electronic display appliqués may be manufactured for example by computer design and wet preparation of displays, computer printing, 3D-printing or other conventional means. Installation may comprise application of a tackifier or adhesive, or may be accomplished by heat lamination or other conventional means of applying appliqués. Another preferred application includes heat shrinking the wrap to ensure it is smoothly and tautly applied. One or more adhesive means may be used. The adhesive layer should also be weather resistant and of a physico-chemical composition that does not interfere with the signal reception or electrical function of the dish. It would be apparent to the ordinary artisan familiar with the use of adhesive fasteners as to the selection of adhesives that may be contemplated for the present invention. The adhesive means may be applied as a layer over all or part of the underside contact surface of the appliqué. The appliqués are then placed over the dish receptor surface, stretched and smoothed into place and then affixed to the surface by a suitable adhesive means. The appliqués should preferably be easily removed, for example by peeling, or with the application of a hot air stream. This allows for interchangeable applications of different laminating indicia.

The inventive appliqué serves as a display for fan loyalty brands, hobby and other affiliation brands. It also serves as an advertising tool that can be used by the dish installer or the consumer to carry promotional messages. Examples of these uses are the roof mounted displays at FIGS. 6, 7 and 8. It is noted that some dishes may be ground mounted. The positive promotional effective of those displays is expected to be the same as the roof-mounted displays. Samples of other laminating indicia targeted with advertising messaging to various customer groups are shown at FIG. 9. Another advantage of having the surface layers of the appliqué indicia on the dish surface is that a smoothened surface is provided that retards the formation of ice and snow buildup, as those deposits tend to slide off the surface.

The advantages of the foregoing described invention further include usefulness of the invention for facilitating a display of fan pride and loyalty; broadcasting ownership or group affiliation; providing advertising displays, including product placements; and fostering brand recognition. The methods and devices of the invention also offer a broader reach for sign advertising, especially in areas where the use of billboards is limited by local ordinances, and it also allows a type of billboard signage in residential areas that would otherwise be unacceptable. A further advantage is that the customized dish offers “ground level” advertising in neighborhoods where people spend most of their time, as opposed to large billboard advertising exposed to cars on the highways. Use of personal satellite dishes for customized advertising also increases dish customer loyalty and promotes dish customer retention.

The foregoing description of specific embodiments is not intended to be limiting on the scope of this disclosure, but rather to be illustrative of the broad concepts embodied by this invention. Those skilled in the art will appreciate that the present invention contemplates the various embodiments of the invention herein described as well as equivalents thereof. Those or ordinary skill in the art will also appreciate that the scope of this invention should be measured by the attached claims as well as by the embodiments herein described.

1. A dish billboard system comprising:
a satellite dish receiver comprising a dish receptor surface on an inner surface thereof, said dish receptor surface circumscribed by a dish receptor edge, and an outer surface; and a dish receiver side edge around the area defined by the surface area of the satellite dish receiver; and
a dish wrap superimposed over the dish receptor surface of the satellite dish receiver, the wrap comprising
a dish wrap appliqué comprised of a seamless uninterrupted film applied over the dish receptor surface to form a tautly stretched, smooth layer on the dish receptor surface;
at least one layer of laminating indicia; and
an adhesive element that affixes the dish wrap to the dish receptor surface;
wherein the dish wrap remains in place over the dish receptor surface and is not removed while the satellite dish receiver is in use.

2. The dish billboard system of claim 1 wherein the dish wrap comprises a single dish wrap appliqué affixed on the entire dish receptor surface.

3. The dish billboard system of claim wherein multiple dish wrap appliqués are affixed on the dish receptor surface, each appliqué covering a portion of the dish receptor surface.

4. The dish billboard system of claim 1 in which the laminating indicia is selected from written information, slogan, logo, image, brand colors or combinations thereof.

5. The dish billboard system of claim 1 wherein the film is comprised of one or more layers selected from the group consisting of polyvinyl chloride (PVC), polymeric acetate, polyethylenes (PET), one or more conductive transmitting layers comprising light emitting microstructures or solar receptors, and combinations thereof.

6. The dish billboard system of claim 1 wherein the adhesive element is comprised of adhesives, heat shrinkable layers, magnetic elements or combinations thereof.

7. The dish billboard system of claim 1 wherein the appliqué comprises one or more layers selected from electronic display layers or electronically conductive layer connected to a power source.

8. The dish billboard system of claim 1 wherein the dish wrap additionally covers the dish side edge of the satellite receiver dish and displays laminating indicia on said dish side edge.

9. The dish billboard system of claim 8 wherein the dish wrap additionally covers the outer surface of the satellite receiver dish and displays laminating indicia on said outer surface.

10. A method of displaying readable information on one or more surfaces of a satellite dish receiver that comprises a dish receptor surface on an inner surface thereof, and an outer surface, said receptor surface circumscribed by a dish receptor edge; and a dish receiver side edge around the area defined by the surface area of the satellite dish receiver, the method comprising:
(a) installing the satellite dish receiver;
(b) superimposing a dish wrap over the dish receptor surface of the satellite dish receiver, said dish wrap being comprised of
a dish wrap superimposed over the dish receptor surface of the satellite dish receiver, the wrap comprising
a dish wrap appliqué comprised of a seamless uninterrupted film applied over the dish receptor surface to form a tautly stretched, smooth layer on the dish receptor surface;
at least one layer of laminating indicia; and
an adhesive element that affixes the dish wrap to the dish receptor surface;
wherein the dish wrap remains in place over the dish receptor surface and is not removed while the satellite dish receiver is in use;
(c) stretching and smoothing the dish wrap appliqué to provide a thin, smooth layer on the dish receptor surface; and
(d) affixing the dish wrap appliqué to the dish receptor surface to provide a dish wrap on which the laminating indicia is displayed while the satellite dish receiver is in use.

11. The method of claim 10 wherein the adhesive element is comprised of adhesives, heat shrinkable layers, magnetic elements or combinations thereof.

12. The method of claim 10 wherein affixing the dish wrap appliqué comprises applying heat to a heat shrinkable adhesive layer of the appliqué.

13. A method of displaying fan loyalty according to claim 10 wherein the laminating indicia comprise names, images, logos or colors associated with sports teams, organizations or social groups.

14. A method of displaying useful or promotional information according to claim 10 wherein the laminating indicia comprise news or social, cultural, community or advertising information.
